(19) United States
(12) Patent Application Publication
(10) Pub. No.: US 2006/0090400 A1
(43) Pub. Date: May 4, 2006

(54) Door opening and closing apparatus

(75) Inventors: Jacob Leendert Los, Abbotsford (CA); Yakov Gofman, Richmond (CA); Mark Esterhuizen, Chilliwack (CA)

Correspondence Address: JONES, TULLAR & COOPER, P.C., P.O. BOX 2266 EADS STATION, ARLINGTON, VA, 22202, US

(73) Assignee: Skyraiser Futures, Ltd., Abbotsford (CA)

(21) Appl. No.: 11/208,009

(22) Filed: Aug. 22, 2005

(30) Foreign Application Priority Data
Aug. 20, 2004 (CA) 2,478,759

(51) Int. Cl. E05F 15/02

(52) U.S. Cl. 49/28

(57) ABSTRACT

An apparatus for opening and closing a door remotely includes a remote control infra red (IR) control, a door hinge mounting assembly and a door opening assembly attached to the door. Also included is remote controlled halogen safety light, a battery pack and charger. The apparatus comprises a battery operated DC gear motor which is activated by a digitally decoded signal which opens and closes a door partially or fully using a two button IR transmitter, latching using an internal mechanism. The apparatus is mounted without deforming any of the structure to which it attaches and is installed with one Allan key which is provided with the unit.

### FIELD OF THE INVENTION

The present invention is directed to a remote controlled apparatus for opening and closing a door. In particular, the assembly uses a rubberized bar and rollers to allow the unit to engage only when powered by using the centrifugal force of the motor body to engage the rollers against the rubber coated bar. This allows the unit to use a small DC motor and low power to open and close doors using regular rechargeable batteries only. Also particular to this invention is that it is free from requiring any of the hardware to puncture or modify the existing structure of the door and frame by using the structure of the door and surroundings to mount the entire unit for operation.

### BACKGROUND OF THE INVENTION

The convenience of a door that opens and closes automatically has led to various attempts in the art to find a solution, none of which have produced a satisfactory result. Conventional door openers attach the unit with screws to the door frame and door. Should the user ever desire to remove the door opener, the door would be visibly marked from attachment of the door opener to the door. Door openers that do not mount to the door only close the door or open the door and use a foot print on the floor that takes up space. Most door openers use hardwired electrical devices because the mechanism requires large amounts of force. Conventional door openers use mechanical clutches and/or cams that directly connect with the door thereby causing wear and requiring maintenance.

### SUMMARY OF INVENTION

One aspect of the present invention relates to an apparatus for opening and closing a door of the type mounted by way of hinges at one outside edge thereof to a door frame. The apparatus has an actuator bar with connection means at one end thereof for pivotal connection to one of the door and the frame and having a uniform bar thickness presenting oppositely disposed drive surfaces therealong. The apparatus also has a force generating unit having a framework for affixing the unit to the other of the door and the frame. The force generating unit comprises a carriage assembly mounted on the framework for swivel movement about an axis relative to the framework and a reversible drive motor having a housing supported by the carriage and an output shaft substantially coaxial with the swivel axis of the carriage. The force generating unit also has a pair of rollers mounted for rotation within the carriage and presenting drive surfaces spaced a distance greater than the thickness of the actuator bar. The output shaft of the motor has a driving connection to at least one of the rollers. In addition a shifter is provided for rotating the carriage about the pivot axis of the carriage to thereby divert a line extending between the axis of the rollers from being in the perpendicular position relative to a longitudinal axis of the actuator bar and to thus bring the surfaces of the rollers into a pinching contact relationship with the opposite drive surfaces of the actuator bar located therebetween.

Another aspect of the invention is provided in an apparatus for opening and closing a door of the type mounted at one outside edge of a door frame by way of door hinges, wherein the hinges are of a two part type including hinging portions consisting of aligned alternate cylindrical portions of each part and receiving therethrough a headed pivot pin. The apparatus includes I) a force generating unit having a framework for affixing the unit to the door, and ii) an actuator bar for interaction with the force generating unit and having at one end a connection portion for pivotally connecting the unit relative to the door frame. The improvement in the apparatus comprises a mounting bracket for attachment relative to the door frame, wherein the mounting bracket includes a flat plate member having a first elongated portion to be positioned over a vertical side portion of the door frame at the outside edge of the door frame and a second upper elongated flat portion extending from a side edge of the first portion for positioning over a top portion of the door frame. The flat plate member has a bar attachment arm extending outwardly therefrom, and the first portion includes along an inner side edge thereof an upper outwardly projecting portion for overlying the headed pin and a lower outwardly projecting portion to underlie the hinge portion of the hinge. Upper and lower clamping members are carried by the upper and lower projecting portions for engagement with the head of the pin and a lower end of the hinging portion of the hinge, respectively. At least one of the clamping members is adjustable toward and away from the hinging portion to thereby clamp the mounting bracket to the hinging portion and in a position to flatly overlie the vertical side portion of the door frame.

### BRIEF DESCRIPTION OF DRAWINGS

FIG. 1 is a perspective view of the apparatus of the present invention as mounted on the inside of a door as usually hinged within a door frame;

Detail 1 -a of FIG. 1 is an enlarged exploded view of a portion of a framework provided for mounting of a force generating unit of the invention at the upper part of the door;

FIG. 2 is an enlarged perspective view of the connection of a mounting bracket of the invention for attaching an actuator bar of the invention to the frame on which the door is hinged;

FIG. 3 is an enlarged upper perspective view of the force generating unit of the invention as seen from an angle and showing parts thereof in more detail;

FIG. 4a is an enlarged perspective view of a carriage assembly for mounting a pair of drive rollers, as seen separated from the remaining force generating unit;

FIG. 4b is a simplified side view of the mounting of a first drive roller as carried by the carriage assembly;

FIG. 5 is a lower perspective view of the unit as shown in FIG. 3, but shown from below, with certain parts removed for the sake of clarity to thereby provide a better understanding of certain parts not visible in FIG. 3;

FIG. 6a is also a lower perspective view similar to FIG. 5 but as seen from a different angle and without the same parts removed as in FIG. 5;

FIG. 6b is a simplified top view of the bar in relation to parts of a latching means;

FIG. 7 is a simplified front view of a plate member of the mounting bracket as connected to a door hinge for attachment of the plate member to the door frame;

FIG. 8 is a sectional view as seen from line 8-8 of FIG. 7;

FIG. 9 is a sectional view as seen through the carriage assembly and illustrating the attachment of a drive motor to a pair of drive rollers in relation to the actuator bar;

FIG. 10 is a simplified top diagrammatic view of the carriage assembly illustrating its motion during drive operations;

FIG. 11 is a view similar to FIG. 10 showing force vectors in relation to the movement of rollers and carriage assembly in operation;

FIG. 12 is a side view of the drive motor in relation to the drive rollers in an alternative form of the drive rollers and actuator bar;

FIG. 13 is a schematic of one embodiment of electronic circuitry for controlling the activity of this drive motor from a remote controller;

FIG. 14 is a flowchart of one embodiment of the function of the electronic circuitry; and

FIG. 15 is a circuit schematic of another embodiment of electronic circuitry for controlling the activity of the drive motor from a remote controller.

### DETAILED DESCRIPTION OF THE INVENTION

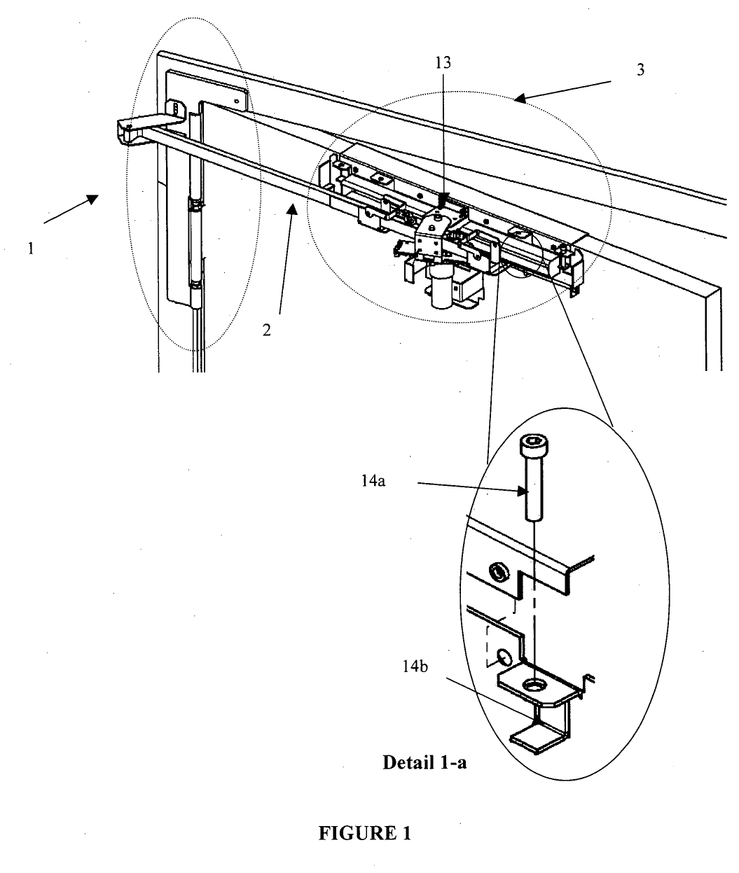

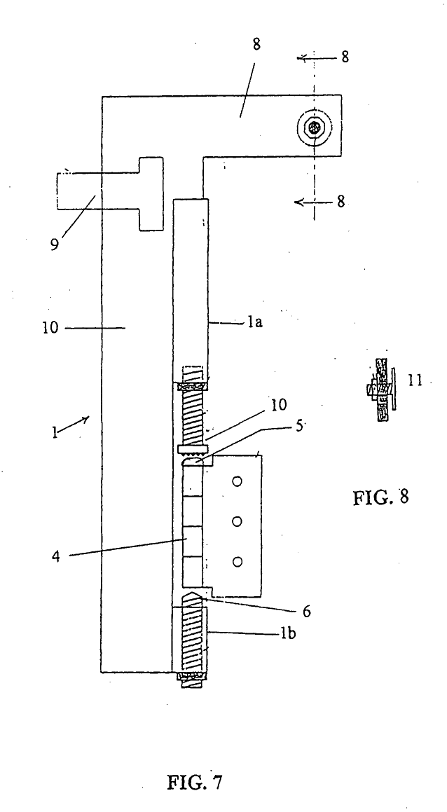

In FIG. 1, there is denoted by reference character 1, a mounting bracket of the invention affixed in a position to overlie a portion of a door frame adjacent a door, at the top of which is mounted a force generating unit 3 providing a drive system engageable with an actuator bar 2 for forcing the door in opening and closing directions. As shown, the door is hinged along one side edge to the door frame by way of hinges 4, one of which is shown. The hinges are of the conventional type formed of two parts, one of which is screw connected to an edge of the door and the other of which is screw connected to a side edge of the door frame. The two parts are connected by a hinging portion consisting of aligned alternate cylindrical portions of each of the two parts. A headed pivot pin is passed through the cylindrical portion, as best illustrated in FIG. 7, to pivotally connect the two parts together.

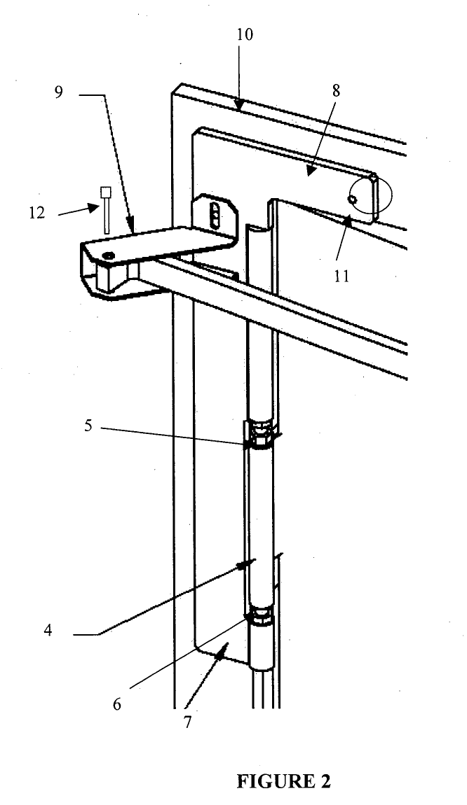

The illustrated mounting bracket, which is attached in closely overlying relation with the adjacent portion of the door frame, consists of a plate member 10 of generally uniform thickness and includes an elongated side portion 7 and an integral top portion 8. As shown, the main or side portion is designed to be positioned over a vertical side part of the door frame adjacent the outside edge of the door, and the integral top portion 8 extends from a side edge of the main portion for positioning over a top portion of the door frame. The side main portion 7 of the bracket is provided with an outwardly extending attachment arm 9 which provides for the fixed pivotal connection at the outer end of the actuator bar 2 by a pivot pin 12 (FIG. 2), the pivotal axis of this connection being displaced from but parallel to the pivotal axis provided for the door by the door hinges.

The manner in which the mounting bracket is held stationary relative to the door frame is better illustrated in FIGS. 2, 7 and 8. The plate member has two outward projecting portions 1b and 1c (FIG. 7) above and below, respectively, of a cut away portion adapted to receive the part of the door hinge making up the hinging portion of the door as described above.

The upper portion la is internally threaded to receive a clamping member in the form of a threaded shank of a headed gripper bolt 10, the head of which is enlarged and serrated, or the like, to provide a lower surface of sharp toothed configuration for engagement with the head of the hinge pin 5. The lower projecting portion 1b is also preferably internally threaded to receive a set screw 6 which is threaded so as to be adjustable toward and away from the lower end of the hinge portion of the door hinge to allow for appropriate adjustment.

Once clamped to the door hinging structure by the setting of screw 6 and tightening of bolt 10, any pivoting movement of the bracket relative to the frame can be eliminated by adjustment of screw system 11 shown more clearly in FIG. 8. This system includes a large headed screw received in a threaded opening located towards the outer end of the top portion 8. By threading the screw in a direction to push the enlarged head against the upper part of the door frame, the bracket swivels slightly to firm up the contact of the side portion 7 against the side door frame. A setting of the screw 11 is locked by an external lock nut on the outside of the upper portion 8 of the bracket.

The manner in which the bracket may be attached in relation to the door frame by way of clamping on to the door hinge is thus apparent, and it can be readily seen that if the door closing mechanism is to be subsequently removed this can be done without any apparent defacing of the door framing.

Additionally, at an upper edge of a main framework 35 of the force generating unit 3, there may be provided a mounting assembly to permit the unit to be detachably connected to the top of the door permitting removal without defacing the door. An example is shown as an over the door mounting bracket 13 in FIG. 1, the bracket encompasses the top of the door and being secured to the door by two screws 14a which push main bracket tabs 14b against the inside of the door (Detail 1-a).

As previously indicated, the actuator bar 2 is only pivotally connected at one end to the attachment arm 9 of the mounting bracket 1 by a pivot pin 12, and this connection allows the actuator 4 to swing only in a horizontal plane. The bar has a uniformly shaped cross section at least for a section to be engaged by driving rollers 21 and 27 which are shown as having cylindrical outer surfaces. In the case of such cylindrical shaped rollers, the oppositely disposed drive surfaces along the portion of the actuator bar 2 engaged by the rollers are parallel flat surfaces. However, should the drive surfaces of the bar be outwardly curved, for example, the driving outer surfaces of rollers 21 and 27 would be suitably concave. The actuator bar is formed of metal, preferably aluminum for the sake of contributing to a light weight, overall system. Moreover, in the situation where the rollers are formed of an urethane material, the portions of the side surfaces of the actuator bar which are engaged by the rollers, i.e., the drive surfaces of the actuator bar, are defined by roller engaging rubber strips formed on the drive surface of the actuator bar to enhance a friction type drive force transferred to the actuator bar by the rotation of the rollers 21, 27.

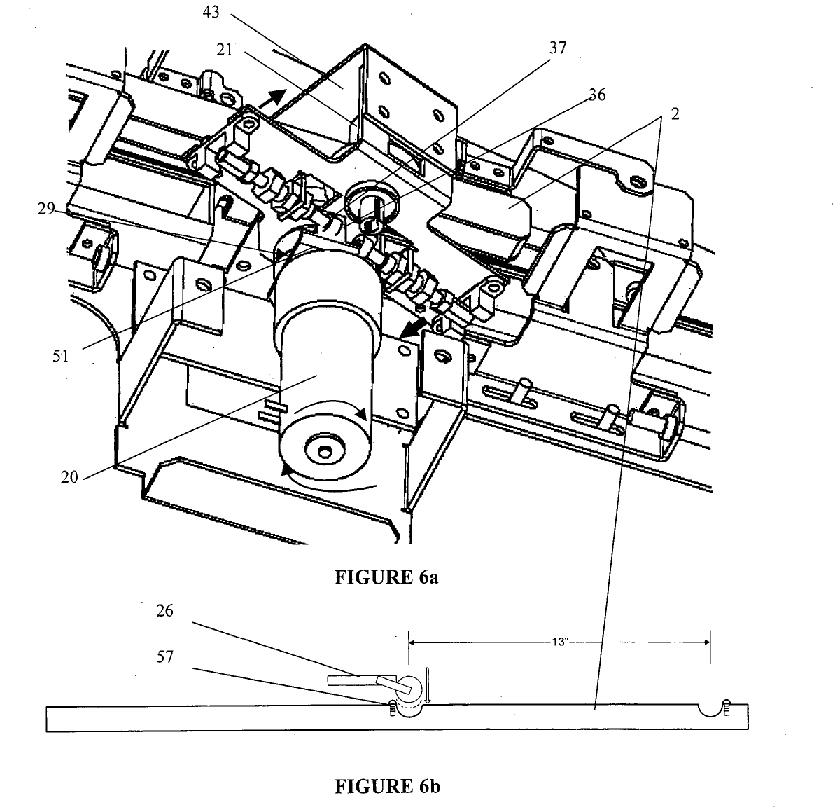

As installed, the overall main framework 35 of the force generating unit, and all of its associated components are provided with a cover (not shown), which is provided with a window to receive the operating signals sent from a remote transmitter. Openings are provided at the opposite ends of the housing to accommodate the portion of a free end of the actuator bar 2. The location of the actuator bar within the apparatus is shown in FIG. 6a. It will become apparent that the overall framework and mechanically operated parts of this system are constructed symmetrically, i.e., as viewed from the top, the opposite sides in relation to a center line, drawn through the pivot point of the carriage assembly, as will be more fully described below, are mirror images of each other. This not only simplifies the overall design and operating characteristics, but permits the door opener of the present invention to be installed on either a right or left hand opening door without any modification or adjustments to the mechanical parts thereof.

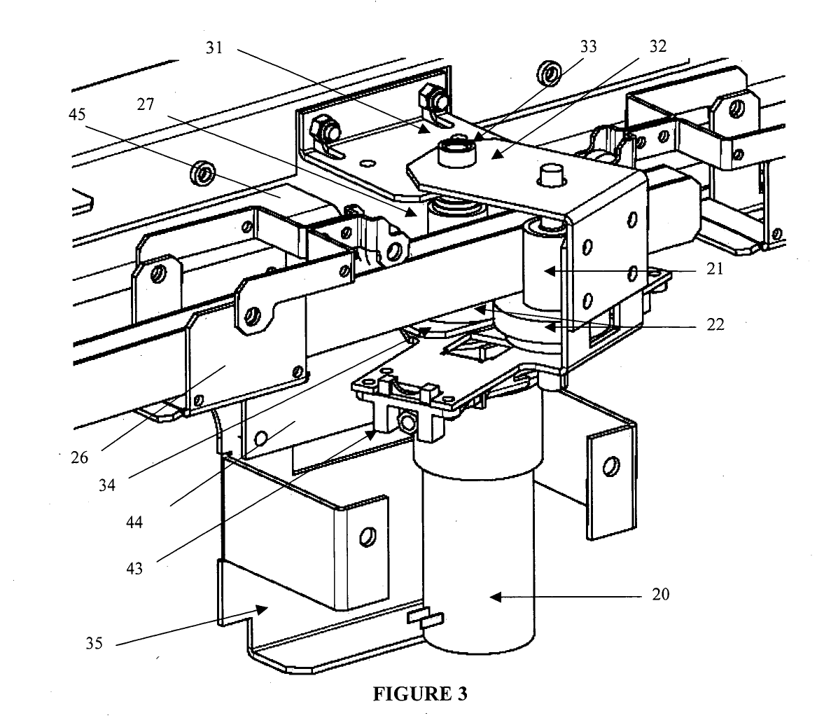

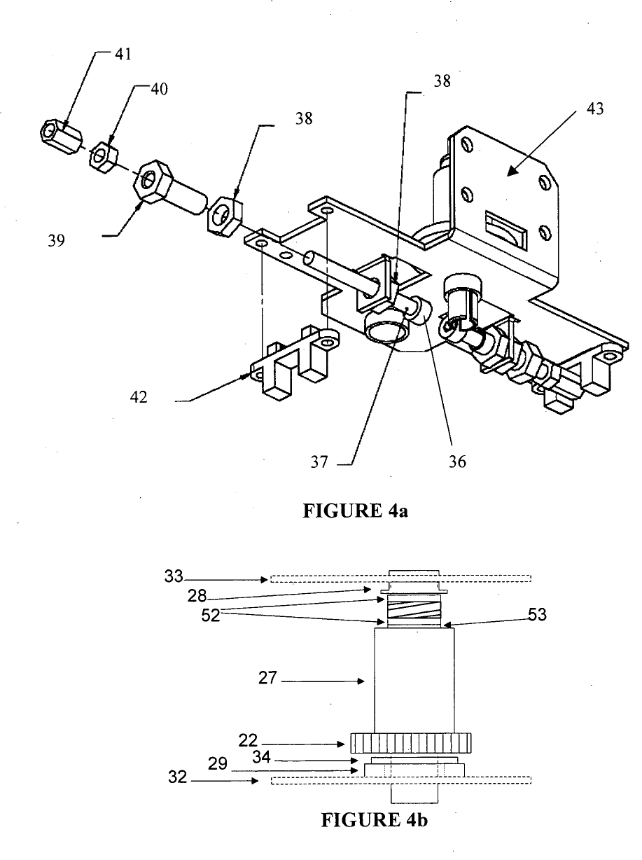

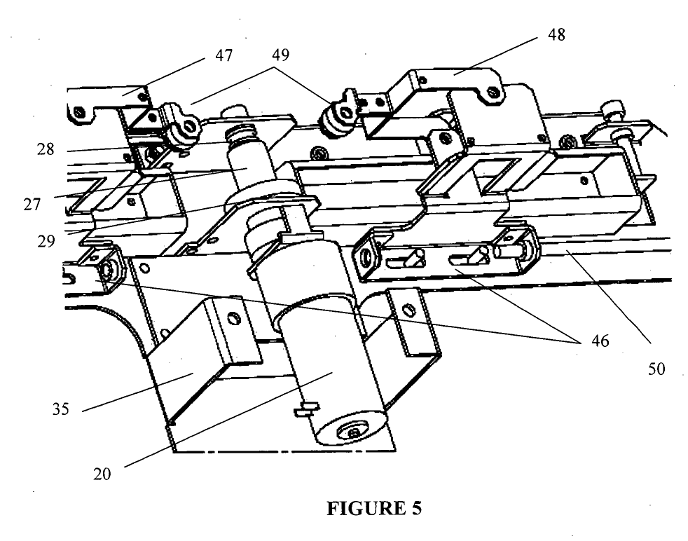

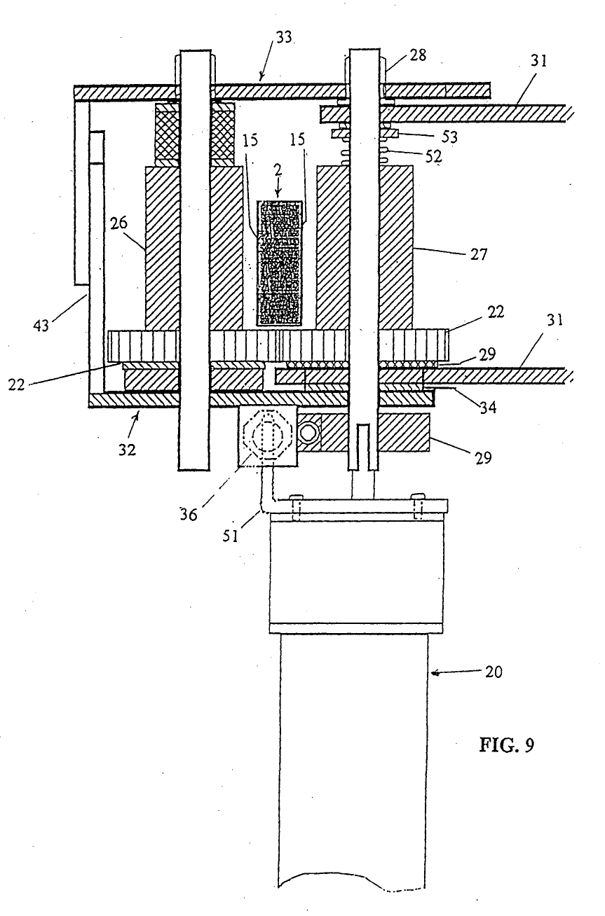

When installed, the portion of the actuator bar 2 remote from its pivotally connected end extends through the overall force generating unit and rests within the pair of spaced bar guide members 26, 26 which are affixed to the framework of the force generating unit, as best seen in FIG. 3. Between the bar guide members 26,26, a portion of the actuator bar 2 is located with a carriage assembly defined by lower and upper plates 32,33 (FIG. 9) which have inner free ends extend above and below the upper and lower frame brackets 31,31 in turn fixed relative to the main framework 35. The lower and upper plates 32, 33 of the carriage assembly are joined at outer ends by overlapping end plates 43. Located between the upper and lower plates forming the carriage assembly are the pair of rollers 21, 27 which are driven so as to move the bar 2 therebetween (FIG. 9). The first driven roller 27, as best seen in FIGS. 4b and 9, is fixed to its own shaft which is journalled for rotation at its upper end by top bushing 28 and its lower end by bushing 34 which allows its shaft to rotate relative to the carriage assembly, and as well the shaft passes through openings in the frame brackets 31,31 and not only rotates free relative to the main framework of the force generating unit, but at the same time provides the pivot shaft for permitting the carriage assembly to pivot relative to the main framework. Additionally, there is provided in fixed relation to the shaft, a gear 22, which is thus driven by the rotation of the shaft of roller 27. For reasons which will become more apparent below, there is provided between bracket 31 and a top surface of the roller 27, a spring 52 and a thrust washer 53. Below the gear 22 and the frame bracket 31, there is provided friction plate 29, which due to the downward pressure exerted by the spring and thrust washer combination 52, 53 provide a small predetermined resistance to the turning of the shaft of the drive roller 27.

A second drive roller 26, also referred to hereinafter as the pinch roller is mounted in fixed relation to its shaft which is rotational driven by gear 22 meshing with the gear 22 of the first drive roller 27. The shaft of roller 26 is mounted for free rotation between the lower and upper plates 32, 33 as is thus carried by the carriage assembly. As indicated above, the second gear 22, which is on the same configuration as the previously described gear on the shaft of the first drive roller 27, is fixed to the shaft of roller 26 so that rotation of the shaft of the roller 27 drives through meshing gears 22, 22 to rotate the second roller or pinch roller 26 at the same speed as drive roller 27.

The axis of rotation of pinch roller 26 is spaced outwardly from the axis of the shaft of roller 27, the latter of which provides the swivel axis of the carriage assembly in which the shaft of the roller 27 is mounted. The spacing of the shafts of rollers 26,27 is such that when a straight line is drawn between the axis of rotation of the rollers, the spacing between the outer surfaces of these rollers is greater than the thickness of the bar as measured between its oppositely disposed driving surfaces 15,15 (FIG. 9). However, as the carriage assembly swivels in either direction from a position wherein the line between the axis of the rollers is not perpendicular to the side surfaces of the actuator bar 2, the distance between the surfaces of the rollers related to the bar decreases. This is because roller 26 in fact travels on an arc about the axis of the first drive roller 27. Swivel motion of the carriage assembly in either direction thus causes the bar to be squeezed or pinched between the two rollers 26, 27 so as to place the surfaces of the rollers in driving contact with the actuator bar.

A reversible drive motor 20 having an output shaft is connected by way of a collar 29 to the lower end of the shaft of the first drive roller 27. The overall motor assembly consists of a DC motor in the lower part thereof connected to the output shaft through a reduction gear system, all of which are contained in a unitary outer housing of the drive motor 20. Connected to the top of the housing of the motor is a torque arm 51 the upper end of which is positioned between a pair of spaced adjustable stops or abutments 36, 36 affixed to a bracket 43 under the lower plate 32 of the carriage assembly (FIGS. 3, 4a and 9). As best seen in FIG. 4a, the abutments or stops 36, 36 include a pair of opposed headed push rods which extend through apertured brackets affixed to the bottom of lower plate 32 of the carriage assembly. The rods are threaded and there is provided between the head of each rod jam nuts 38 and springs 37. Outwardly of the apertured bracket an additional jam nut 38 is provided, as well as a modified hex bolt 39, and threaded standoff 41. Also, attached to the lower plate 32 are a pair of detectors in the form of two photo-interrupters 42, appropriately located in relation to the outer end of the assembly making up the abutment components so as to be activated depending on the position of push rods.

As can be seen in FIG. 4, the previously described guide members 26 pivotally carry at the tops thereof lever members 47 and 48 having roller type followers 49 at the outer ends thereof. These followers, which are diagrammatically illustrated in FIG. 6b are disposed to ride on top of the bar 2 as it moves relative to the framework of the force generating unit during actuation of the drive rollers 21, 27. The relative longitudinal positioning of the followers 49 can be selected by way of slotted brackets 46 and abutment bolt 50 capable of shifting the entire guide member 26 on which the levers 47 and 48 are carried. As illustrated in FIG. 6b the upper surface of the bar may be formed with two notch defining means into which the roller type follower may fall when the actuator bar 2 has reached the selected position. Preferably, springs are connected between the lever members and the guide members 26 to provide a downward biasing force on the followers 49 and thereby provide positive engagement of the followers with the top of the bar 2 as well as a holding force on the rollers when in the detent engaging position.

With reference now to the simplified top view of the carriage assembly in FIG. 11, it may be seen that when the motor has been given a signal to drive the roller 27 in the direction of arrow A, roller B is driven in the direction of arrow B by the meshing gears so that through the engagement of the surfaces of the rollers 26, 27 with opposite side surfaces of the actuator bar, the actuator bar is driven, relative to the force generating unit, in the direction of the arrow C. Due to the action of the shifter, as will be described in more detail below, the carriage assembly has been moved in the direction of arrow D, whereby the relative movement of the axis of the roller 21 with the shifting of the carriage causes a pinching effect by the surfaces of the rollers therebetween, whereby the actuator bar is moved at the same velocity as the surfaces of the rollers through frictional engagement.

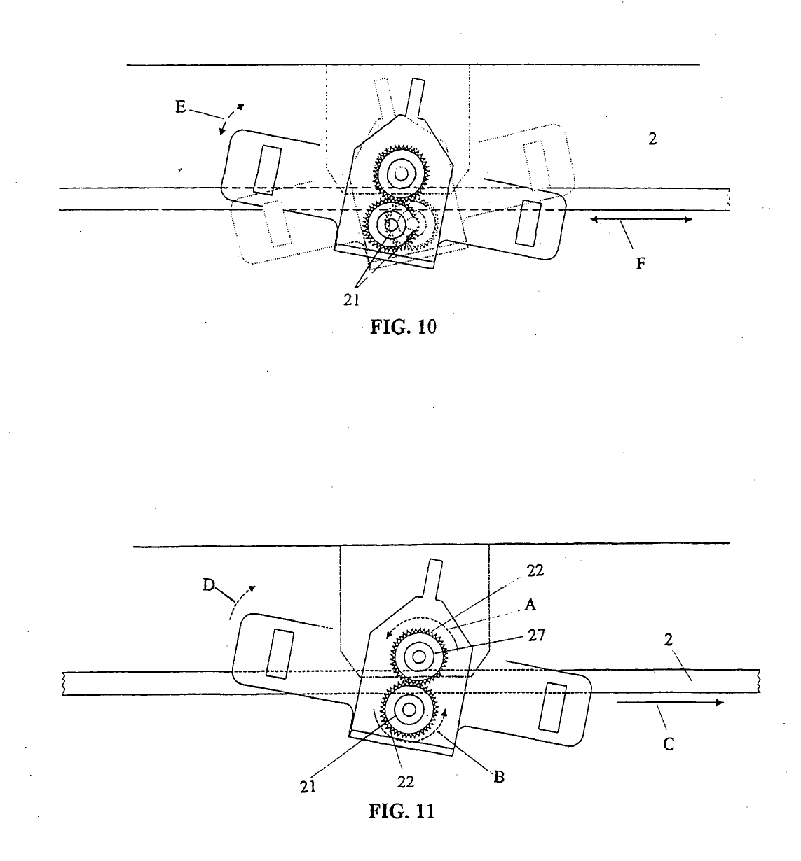

FIG. 10 indicates the manner in which the carriage assembly oscillates back and forth between two extreme positions as indicated by arrow E, as the direction of rotation of the rollers is reversed. The reversal is made to drive the actuator bar 2 in either of the two directions (arrow F) and accomplish both opening and closing of the door. It further illustrates the two alternative positions of the drive roller 21, also referred to as the pinch rollers, as the carriage assembly is shifted between its two extreme positions. Between the two extreme positions illustrated, the rollers are no longer in drive contact with the actuator bar.

When the motor 20 drives the roller 27 in direction A (FIG. 11), and if the motor had previously terminated an operation moving the bar 2 in the opposite direction, the carriage assembly would first shift from the position shown in dotted lines in FIG. 11 to that shown in solid lines. The shifting is brought about basically by the reactionary force developed in the motor housing on the starting of the motor output shaft to turn in the direction of arrow A of FIG. 11, i.e., the reactionary force in the housing would be in the opposite direction to that shown at A in this Figure. The reactionary force of the housing of the motor causes the torque arm 54, which is affixed to the motor housing, to turn in a direction to engage the appropriate stop 36 and to push the carriage in a direction which is opposite to the direction of output of the motor shaft, again in the direction of the arrow A, thus resulting in the rotation of the carriage assembly as indicated by D in FIG. 11. The same procedure follows in the opposite direction if the motor is activated to drive the actuator bar in the opposite direction, i.e., the housing of the drive motor turns by way of a reactionary force in the opposite direction to that of its output shaft, and through the opposite stop 36 pushes the carriage assembly in the opposite direction to that shown by arrow D of FIG. 11.

At the start-up of the motor, because the rollers are not in tight engagement with the bar, provision is made to increase the resistance to the rotation of the rollers and thereby increase the reactionary force on the carriage assembly for moving the carriage assembly. This is done through the provision of friction plate 29 which is provided in conjunction with roller 27 as described above. Thus the shifting of the carriage assembly to its new position on starting of the motor is ensured regardless of the mode in which it rested during the previous shut down of the motor. Moreover, in the structure shown for the abutment or stops 26, 26 described above, the amount of resistance provided by the resilient means or spring 37 to movement of the push rod 36 due to the force provided can be varied. The force on the push rod is provided by the torque arm of the motor housing pushing the carriage assembly to its new position and holding it there. The position of the push rod in relation to the magnitude of push is thus variable by adjusting the amount of compression on the spring. A variation in position of the push rod or changing the effect of the movement of the push rod through changing its position is useful in determining the activation or deactivation of the detectors or photo interrupter 42, which is thus useable in discontinuing the operation of the motor under certain conditions. It is also possible to include in the electronic control system a reverse of the motor voltage for a short period of time, say 1/10 of a second causing the carriage assembly to move to have the rollers disengage the actuator bar 2 and move to its neutral position by means of counter forces instantly effected, particularly due to the action of the friction device provided in relation to roller 21.

The system further provides for what may be termed a latching system by way of the spring loaded followers which seat in the notches provided in the top surface of the actuator bar 2 as illustrated in FIG. 6b. When the followers engage one of the detents and seat within the detent, this seating causes an increase in resistance to the motor driven system and causes the door to position itself and to terminate the door opening or closing action. As illustrated in FIG. 6b, the addition of a screw 57 adjacent the notch may be included to provide more resistance than the system can exert and therefore the door will stay in its set position. The settings may be such that forces as applied by a manual effort to move the door to a different position will overcome the resistance to move the rollers out of the notch. This might be done, for example, to allow the door to shut sufficiently to latch in its own latching system.

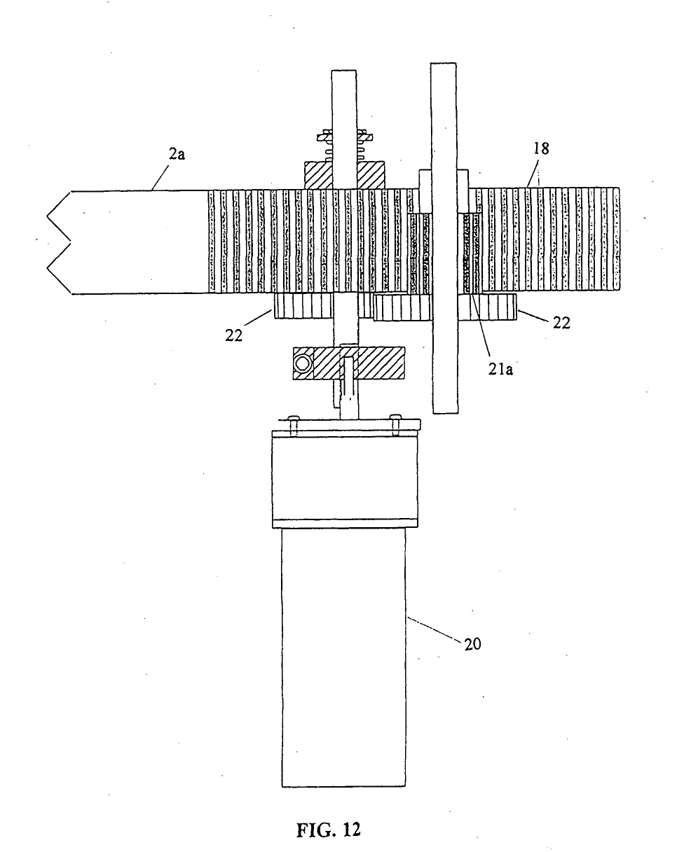

In the alternative embodiment of the invention shown in FIG. 12, the entire drive system is the same as previously described, except unlike the above embodiment, the roller engaging surface along one side of the actuator bar 2a is not a flat rubberized surface, but the actuator bar is provided with a surface of equally spaced vertically extending ribs 18. Also the pinch roller 21 a does not have a smooth surface but has teeth spaced to mesh with the ribs to provide a direct drive rather than a frictional one between the pinch roller 21a and the bar 2a. This form of drive may be preferable for a more heavy duty operation or where the device is under continual operation such as in a public washroom door application. The toothed roller 21 a may be formed of aluminum and the teeth ribs on the bar may be attached to one side of the actuator bar by a belt of a nylon reinforced rubber.

As compared to known door opener and closers, the drive system of the present invention is formed of light parts which are of simple and inexpensive structure. It can be seen that the number of moving parts are few and yet capable of transmitting forces to the actuator bar automatically in opposite directions requiring no separate actual mechanics for engaging drive from the motor to the actuator bar. The combination of the actuator bar and the force generating unit are capable of being mounted on either a left hand or right hand opening door entirely without modification to either component. The drive through the carriage system is ideal for a friction drive between the drive rollers and the actuating bar, as any increase in resistance to movement of the door within predetermined limits is automatically compensated for as the load increases because the swivel mounting of the carriage assembly is forced in a direction to increase the contact pressure between the rollers and the actuator bar. The required interaction between the mechanical actuating components and the controls for providing signals for use in achieving the necessary operations are also simplified through use of the swivel carriage assembly of the invention.

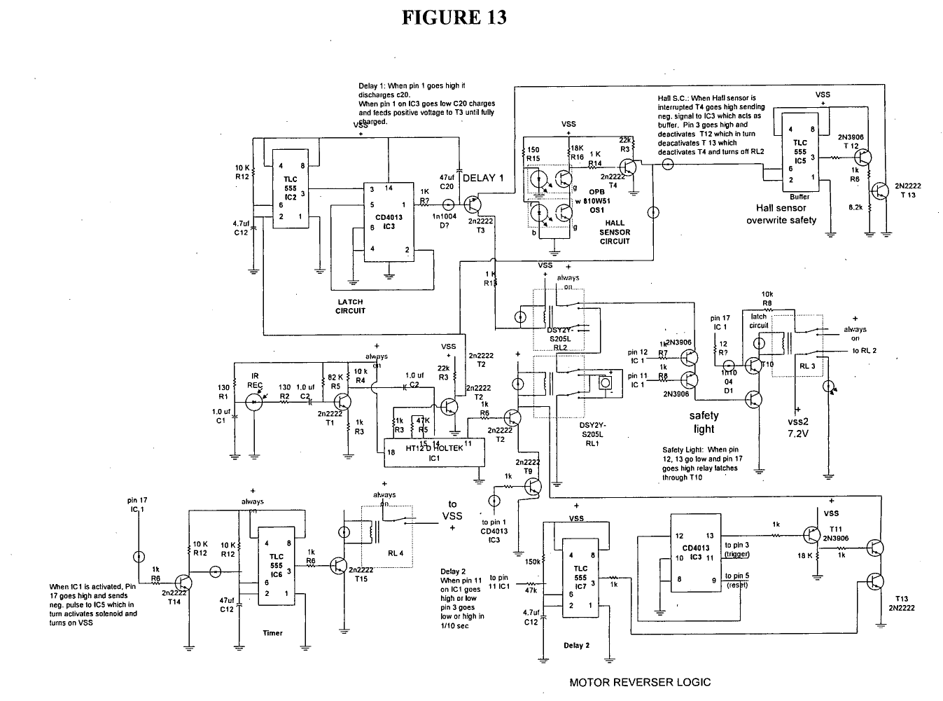

Referring now to FIGS. 13, 14 and 15, sample embodiments of the electronics control systems are shown. With reference to the exemplary embodiment of FIG. 13, the functional operation of this circuit is as follows:

Stage O:

Unit in sleep mode. Timer circuit looks for signal from 1C 1 (addressed signal from hand help remote control or transmitter—other IR signals will not trigger circuit).
   Stage 1:
Pressing any of two buttons of the transmitter will bring receiver out of sleep mode.
   Stage 2:
Press left button on transmitter, Unit activates relay RL 1 (on off switch) and RL 2 (motor direction control) (door opens on left hinged doors, reverse for right hinged).
   Stage 2a:
Press any button of the transmitter while the door is moving and RL 2 switches off, RL 1 remains active for 1/10 sec. Functionally this reverses motor for a split second to allow mechanism to disengage and then stops door movement. Press open button on transmitter again and RL 1 and RL 2 are re-engaged and continues opening of the door.
   Stage 2b:
When RL 1 is engaged so that the door is moving in any direction, and the door encounters resistance (chair or person standing by the door) OS 1 is deactivated and shuts off RL 1 and the door stops. The Hall sensor overwrite safety circuit (IC 5 and T12, T13) disengage RL 1 through T13 as long as OS 1 id deactivated. This avoids motor from being re-engaged when remote remains activated continuously.
   Stage 2c:
After each activation of the remote transmitter the timer (1 C 8) counts 15 seconds upon which the circuit goes back to “sleep” stage. Every push of any of either buttons of the transmitter reactivates the Time to 15 seconds.
   Stage 3:
When door reaches fully open position (90-120 degrees) OS 1 is deactivated which triggers the latch circuit and activates or deactivates RL 2 (reverse of current state) and after 1/10 sec. deactivates RL 1. Seconds later the timer will shut down the system.
   Stage 4:
Closing the door. The right button of the transmitter will always perform all the same functions as the left button but always deactivates RL 2 when button is engaged. This will move the door in the opposite direction. The door will have the same functions as Stage 2a through Stage 3.

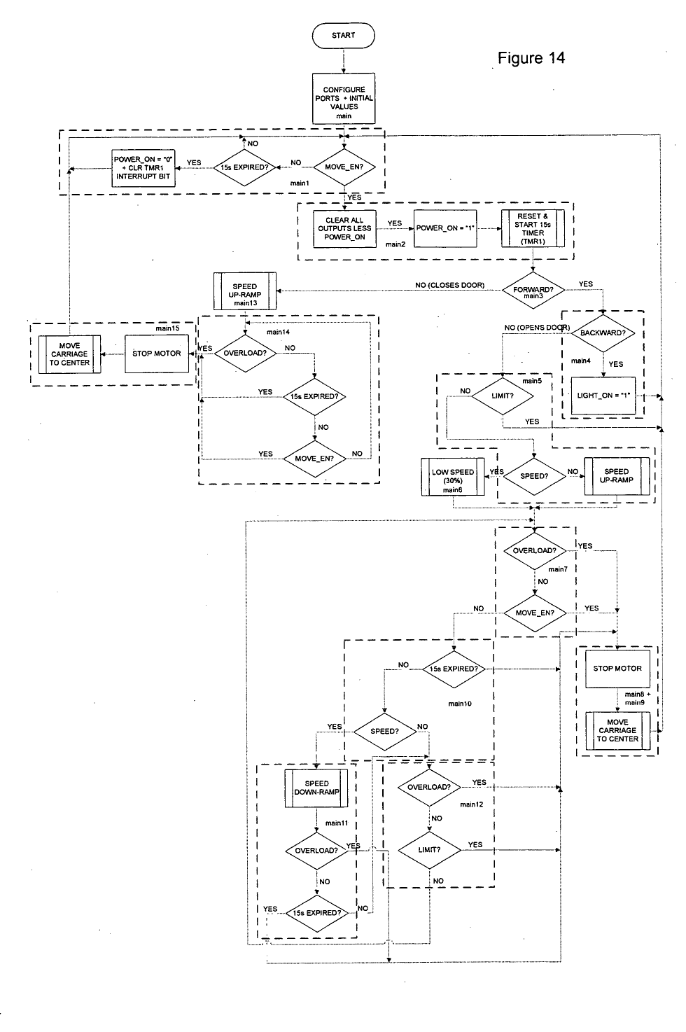

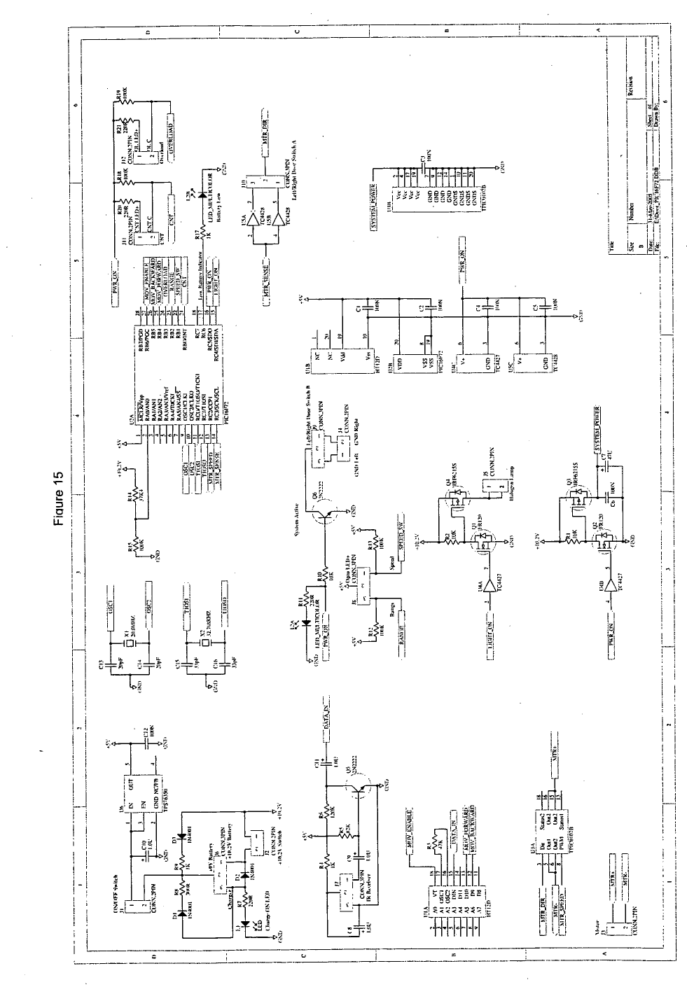

FIG. 14 shows a flowchart of another exemplary operation of the circuitry used to control the present invention. Such a flowchart can be used with a computer program such as Microchip MLAB in order to prepare a circuit and load the circuit onto a microchip. An example of such a circuit is shown in FIG. 15.

1. An apparatus for opening and closing a door of the type mounted by way of hinges at one outside edge thereof to a door frame, the apparatus comprising;
an actuator bar having connection means at one end thereof for pivotal connection to one of said door and said frame and having a uniform bar thickness presenting oppositely disposed drive surfaces therealong, and
a force generating unit having a framework for affixing said unit to the other of said door and said frame;
said force generating unit comprising:
a carriage assembly mounted on said framework for swivel movement about an axis relative to said framework,
a reversible drive motor having a housing supported by said carriage and an output shaft substantially coaxial with the swivel axis of the carriage,
a pair of rollers mounted for rotation within said carriage and presenting drive surfaces spaced a distance greater than said thickness of said actuator bar,
said output shaft of said motor having a driving connection to at least one of said rollers, and
a shifter for rotating said carriage about the pivot axis of said carriage to thereby divert a line extending between the axis of the rollers from being in the perpendicular position relative to a longitudinal axis of the actuator bar and to thus bring said surfaces of said rollers into a pinching contact relationship with said opposite drive surfaces of said actuator bar located therebetween.

2. The apparatus as defined in claim 1, wherein;
said shifter includes a connection between said motor housing and said carriage assembly for transferring a reactionary force established in said housing by the driven rotation of said output shaft so as to shift the carriage assembly and move the rollers to the pinching contact relationship with said actuator bar.

3. The apparatus as defined in claim 2, wherein;
said pair of rollers includes a first roller having a coaxial drive shaft mounted in aligned relation to and drivingly connected to said output shaft of said motor.

4. The apparatus as defined in claim 3, wherein;
a second roller of said pair has a coaxial drive shaft in parallel spaced relation to said drive shafts of said first roller, said drive shafts of said rollers being journalled for rotation in relation to said carriage assembly.

5. The apparatus as defined in claim 4, wherein;
said drive shafts of said rollers are drivingly connected for synchronized rotation at a common peripheral speed in opposite direction to thereby both provide to said oppositely disposed drive surfaces of said actuator bar driving forces in the same longitudinal direction.

6. The apparatus as defined in claim 5, wherein;
a pair of meshing gears, one each affixed to the drive shafts of said rollers, provide rotation of equal speed but in opposite directions of rotation to said pair of rollers.

7. The apparatus of claim 4, and further comprising;
a torque arm affixed to the said housing of said drive motor at a distance from said output shaft,
a pair of stops affixed to said carriage assembly, one each on opposite sides of said torque arm and located for engagement by said torque arm for respective engagement therewith as said housing experiences opposite reactionary forces on reversing drive of said motor, whereby a force is provided through said torque arm engagement respectively with each stop to swivel said carriage assembly between opposite drive positions.

8. The apparatus as defined in claim 7, and further comprising;
mounting means between said stops and said carriage permitting limited movement of said stops relative to said carriage,
said mounting means including resilient elements resisting said movement, and
detectors located adjacent said stops and providing a signal on detection of a predetermined amount of movement of said stops relative to said carriage.

9. The apparatus as defined in claim 8, and further comprising;
electric circuitry for providing power to said drive motors, and switch means for terminating flow of power to said motor on receiving a signal from either of said detectors indicating the existence of said predetermined amount of movement of said stop means.

10. The apparatus of claim 8, and further comprising,
a resilient adjuster element for each of said stops for selecting the amount of resistance to movement of each stop in relation to the reactionary force transmitted by said torque arm.

11. The apparatus as defined in claim 4, and further comprising;
a rotational resisting device associated with one of said rollers for increasing the requirement for output torque to rotate said rollers whereby the reactionary forces experienced by said housing of said drive motor is increased.

12. The apparatus as defined in claim 11, wherein said rotational resisting device includes a biasing means providing an end thrust at one end of said one of said rollers and a friction member disposed between the opposite end of said one end of said rollers and an element stationary relative to the rotation of said one of said rollers so as to provide a predetermined resisting force to rotation of said roller.

13. The apparatus as defined in claim 9, and further comprising;
a door latching mechanism for maintaining said door in a preselected position,
said mechanism including an actuator bar engaging member for applying resistance to further drive of said actuator bar by way of said rollers.

14. The apparatus as defined in claim 13, wherein;
said door latching mechanism includes a notch defining means in said actuator bar, and
a latch means mounted on said framework and engageable with said actuator bar and positioned to enter said notch and provide sufficient resistance of movement of said actuator bar relative to said force generating unit to activate said switch means to thereby terminate flow of power to said drive motor.

15. The apparatus as defined in claim 14, wherein;
the interaction between said latch means on said means defining said notch is gauged to be insufficient to resist relative movement between such actuator bar and said force generating unit when said door is manually moved.

16. The apparatus as defined in claim 14, wherein said latch mechanism includes;
a lever pivotally connected to said framework,
a follower member carried by said lever for engagement with said actuator bar during movement of said actuator bar relative to said force generating unit,
means biasing said lever in a direction to force said follower member to enter said notch defining means.

17. The apparatus as defined in claim 4, wherein;
said drive surfaces of said actuator bar are defined by roller engaging rubber-like strips, and
said rollers are formed with polyurethane bar engaging surfaces, whereby said driving forces generated between said rollers and said bar are due to frictional engagement.

18. The apparatus as defined in claim 4, wherein;
the drive surface of said actuator bar engaged by said second roller is defined by plurality of spaced ribs therealong, and
second roller has an actuator bar engaging surface defined by a plurality of longitudinally extending teeth spaced for engagement between said ribs whereby a positive drive is exerted between said second roller and said actuator bar.

19. In an apparatus for opening and closing a door of the type mounted at one outside edge of a door frame by way of door hinges, and wherein said hinges are of a two part type including hinging portions consisting of aligned alternate cylindrical portions of each part and receiving therethrough a headed pivot pin, said apparatus including I) a force generating unit having a framework for affixing said unit to the door, and ii) an actuator bar for interaction with said force generating unit and having at one end a connection portion for pivotally connecting said unit relative to said door frame;
the improvement comprising a mounting bracket for attachment relative to said door frame, said mounting bracket including;
a flat plate member having a first elongated portion to be positioned over a vertical side portion of said door frame at said outside edge of said door frame and a second upper elongated flat portion extending from a side edge of said first portion for positioning over a top portion of said door frame,
said flat plate member having a bar attachment arm extending outwardly therefrom,
said first portion including along an inner side edge thereof an upper outwardly projecting portion for overlying the said headed pin and a lower outwardly projecting portion to underlie said hinge portion of said hinge,
upper and lower clamping members carried by said upper and lower projecting portions for engagement with the head of said pin and a lower end of said hinging portion of said hinge, respectively,
at least one of said clamping members being adjustable toward and away from said hinging portion to thereby clamp said mounting bracket to said hinging portion and in a position to flatly overlie said vertical side portion of said door frame.

20. The improvement of claim 19, and further comprising an adjustable frame contacting member including a flat head and a threaded shank received in a threaded bore in said upper portion of said bracket for movement of said flat head into contact with said top portion of such door frame.

21. The improvement of claim 17, wherein;
said upper outwardly projecting portion of said first portion of said flat plate member includes a threaded bore for receiving a threaded shank of an upper one of said clamping members to permit upwardly and downwardly positioning of said upper clamping member, the upper clamping member including an enlarged lower end surface of sharp toothed configuration for engagement with said head of the hinge pin.

22. The improvement of claim 19, wherein;
said lower projecting portion of said first portion includes a threaded, vertical bore receiving a threaded shank of a lower adjustment member having an upper end for engaging with a lower end of the lowermost cylindrical portion of said hinge parts.
